(19) United States
(12) Patent Application Publication
(10) Pub. No.: US 2024/0284262 A1
(43) Pub. Date: Aug. 22, 2024

(54) SYSTEMS AND METHODS FOR DELAY-AWARE TRAFFIC PROVISIONING FOR BURSTY WIRELESS NETWORK COMMUNICATION TRAFFIC

(71) Applicant: Meta Platforms Technologies, LLC, Menlo Park, CA (US)

(72) Inventors: Zhu JI, Cupertino, CA (US); Liwen YU, Santa Clara, CA (US); Yee Sin CHAN, San Francisco, CA (US); Jimin LIU, Bellevue, WA (US); Kyunghun JUNG, Sunnyvale, CA (US); Xiaodi ZHANG, San Ramon, CA (US); Curt WONG, Bellevue, WA (US)

(73) Assignee: Meta Platforms Technologies, LLC, Menlo Park, CA (US)

(21) Appl. No.: 18/541,888

(22) Filed: Dec. 15, 2023

Related U.S. Application Data
(60) Provisional application No. 63/446,207, filed on Feb. 16, 2023.

(51) Int. Cl. H04W 28/22; H04W 56/00

(52) U.S. Cl. CPC H04W 28/22; H04W 56/001

(57) ABSTRACT

Disclosed herein are aspects related to a device that can include a wireless communications interface and one or more processors. The wireless communications interface can be to communicate a plurality of data packets and/or a data burst to a network device. The one or more processors can generate the plurality of data packets according to a timing characteristic of the one or more data packets. The one or more processors can provide an indication of the timing characteristic to the network device. The one or more processors can receive a communication rate from the network device. The one or more processors can cause the wireless communications interface to communicate the plurality of data packets to the network device according to the communication rate.

### CROSS-REFERENCE TO RELATED APPLICATIONS

The present application claims the benefit of and priority to U.S. Provisional Application No. 63/446,207, filed Feb. 16, 2023, the disclosure of which is incorporated herein by reference in its entirety.

### FIELD OF DISCLOSURE

The present disclosure is generally related to communication for rendering artificial, mixed, virtual, or extended reality, including but not limited to systems and methods for delay-aware traffic provisioning for bursty wireless network communication traffic.

### BACKGROUND

Artificial/extended reality (XR) such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space).

### SUMMARY

Systems that implement XR can transmit data to and receive data from remote devices, such as network base stations, as part of providing XR experiences. Due to various factors including size, weight, and power considerations, it can be useful for such systems, such as portable user equipment (UE) devices, to control or limit the durations in which wireless communications are active for transmission and/or reception operations. However, such control can affect quality of service (QOS) of the XR experience, such as by affecting latency; similarly, XR data, such as video frames to be presented in an order, may be expected to be delivered according to a periodic schedule (e.g., frame rate), and thus such systems can cause data to be discarded rather than transmitted/received after the data would be useful, which can affect (e.g., reduce) QoS.

Systems and methods in accordance with the present disclosure can allow for more effective allocation of communication grants to devices, such as for communication of XR data. For example, a device (e.g., user equipment) can determine a timing characteristic of data to be transmitted using a network connection to a network device. The device can determine, for example, the timing characteristic to indicate whether the data is periodic or aperiodic and/or receiver-triggered (e.g., requested from an application server). The device can communicate an indication of the timing characteristic to the network device, which can enable the network device to more effectively allocate uplink grants (e.g., bit rate, bandwidth, etc.) to the device for transmission of the data packets to the network device in accordance with the uplink grants.

Various implementations disclosed herein are related to a device that can include a wireless communication interface and one or more processors. The one or more processors can generate the plurality of data packets according to a timing characteristic of the one or more data packets. The one or more processors can provide an indication of the timing characteristic to the network device. The one or more processors can receive a communication rate from the network device. The one or more processors can cause the wireless communications interface to communicate the plurality of data packets to the network device according to the communication rate.

In some implementations, the plurality of data packets are representative of video frames, and the timing characteristic corresponds to a compression of the video frames being intra-frame compression or inter-frame compression. The one or more processors can generate the indication based on the inter-frame compression having a greater data usage than the inter-frame compression. The plurality of data packets can form a data burst.

In some implementations, the timing characteristic corresponds to the plurality of data packets being representative of periodic data. The one or more processors can generate a user assistance information (UAI) signal comprising the indication of the timing characteristic and transmit the UAI signal to the network device to provide the indication of the timing characteristic to the network device. The one or more processors can communicate the indication to the network device using radio resource control (RRC) signaling. In some implementations, the one or more processors can communicate the indication of the timing characteristic to the network device, using at least one of a uplink control information (UCI) signal or a media access control (MAC) control element (CE) signal, responsive to a determination that the timing characteristic corresponds to at least one of the one or more data packets being aperiodic or being receiver-triggered.

Various implementations disclosed herein relate to a system. The system can include a first device and a second device. The first device can include one or more first processors to generate a plurality of data packets according to a timing characteristic of the one or more data packets. The second device can include one or more second processors. The one or more second processors can receive an indication of the timing characteristic from the first device. The one or more second processors can transmit, to the first device, according to the indication of the timing characteristic, a communication rate for communication of the plurality of data packets from the first device to the second device.

In some implementations, the plurality of data packets are representative of video frames, and the timing characteristic corresponds to a compression of the video frames being intra-frame compression or inter-frame compression. The one or more first processors can generate the indication based on the inter-frame compression having a greater data usage than the inter-frame compression. The plurality of data packets can form a data burst.

In some implementations, the timing characteristic corresponds to the plurality of data packets being representative of periodic data. The one or more first processors can generate a user assistance information (UAI) signal comprising the indication of the timing characteristic and transmit the UAI signal to the second device to provide the indication of the timing characteristic to the second device. The one or more first processors can communicate the indication to the network device using radio resource control (RRC) signaling. In some implementations, the one or more first processors can communicate the indication of the timing characteristic to the second device, using at least one of a uplink control information (UCI) signal or a media access control (MAC) control element (CE) signal, responsive to a determination that the timing characteristic corresponds to at least one of the one or more data packets being aperiodic or being receiver-triggered.

Various implementations disclosed herein relate to a method. The method can include generating, by one or more processors, a plurality of data packets. The method can include determining, by the one or more processors, a timing characteristic of the plurality of data packets. The method can include transmitting, by the one or more processors, using a wireless communications interface, an indication of the timing characteristic to a network device. The method can include receiving, by the one or more processors, from the network device, a communication rate for the plurality of data packets. The method can include transmitting, by the one or more processors, using the wireless communications interface, the plurality of data packets to the network device.

In some implementations, the plurality of data packets are representative of video frames, and the timing characteristic corresponds to a compression of the video frames being intra-frame compression or inter-frame compression. The method can include generating the indication based on the inter-frame compression having a greater data usage than the inter-frame compression. The plurality of data packets can form a data burst.

In some implementations, the timing characteristic corresponds to the plurality of data packets being representative of periodic data. The method can include generating a user assistance information (UAI) signal comprising the indication of the timing characteristic and transmit the UAI signal to the second device to provide the indication of the timing characteristic to the second device. The method can include communicating the indication to the network device using radio resource control (RRC) signaling. In some implementations, the method includes communicating the indication of the timing characteristic to the second device, using at least one of a uplink control information (UCI) signal or a media access control (MAC) control element (CE) signal, responsive to a determination that the timing characteristic corresponds to at least one of the one or more data packets being aperiodic or being receiver-triggered.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of an example wireless communication system, according to an example implementation of the present disclosure.

FIG. 5 is a block diagram of a system for delay-aware traffic provisioning, according to an example implementation of the present disclosure.

FIG. 6 is a diagram depicting a process for facilitating delay-aware traffic provisioning, according to an example implementation of the present disclosure.

FIG. 7 is a flow chart of a method of traffic provisioning for wireless network communication traffic, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Systems and methods in accordance with the present disclosure are related to implementing a communication system that can implementing a system that can perform network provisioning, such as for uplink traffic communication of XR data. Some data communications, including but not limited to XR data network traffic, can have bursty properties; for example, the data can vary significantly in amounts of data over time, such as to have factors of two, five, or more of volumes of data to be communicated during portions of a period of time relative to other portions of the period of time. For example, video data and other data that uses compression processes may include representations of the video data including both intra-frame compression representations (which may be relatively high in data volume) and inter-frame compression representations (which may be relatively low in data volume; e.g., the volume of data for communicating a frame using intra-frame compression may be 5-10 times that for inter-frame compression).

Various quality of services (QOS) rules and/or classifications may be applied to network data traffic (e.g., an IP flow), including protocol data units (PDUs) and data bursts. For example, UL/DL traffic classification can be based on packet detection rules for DL and/or a UL traffic filter for UL; various tuples (e.g., source IP, destination IP, source port, destination port, protocol ID) can be used to perform the classification.

Some systems may use criteria associated with the amount of data to be communicated, such as prioritized bit rates (PBRs) or guaranteed bit rates (GBRs); these criteria may be configured for an associated data flow as the average rate of data scheduled for communication using a corresponding logical channel. To meet delay criteria, the performance criteria (e.g., bit rates) may be set to relatively high values, such as greater than the average bit rate of traffic, so that most of the XR data can be scheduled and transmitted as it arrives; this can result in over-allocation as the network has to give up (e.g., not allocate to other data flows) uplink capacity to satisfy latency criteria; data bursts may also exceed the average bit rates, such that there may be under-allocation when data bursts occur.

Systems and methods in accordance with the present disclosure can use information regarding the amount of data for data packets to more effectively allocate network elements (e.g., uplink grants) for data communication. For example, user equipment (UE) devices can communicate to a network device (e.g., base station) an indication of the data packets having intra-frame compression (e.g., relatively high data flow rate data) or inter-frame compression (e.g., relatively low data flow rate data). This can enable data flow rate allocation (e.g., bit rates) to be determined more accurately with respect to the type of data to be communicated, such as to determine an average bit rate for intra-frame compressed frames and an average bit rate for inter-frame compressed frames. For example, for periodic data (e.g., periodic uplink intra-frame compression), the UE can communicate the indication using user assistance information (UAI), such as by using radio resource control (RRC) signaling. For example, for a-periodic or receiver-trigger communications, the UE can communicate the indication using uplink control information (UCI) and/or MAC control element (CE) signaling.

In some implementations, a device includes a wireless communications interface and one or more processors. The one or more processors can identify a type of data of one or more data packets, such as a type of compression applied to (or to be applied to) the one or more data packets. The one or more processors can provide an indication of the type to a network device, such as a base station. The one or more processors can cause the wireless communications interface to communicate the one or more data packets based at least on a response from the base station corresponding to the type (e.g., responsive to the base station determining a bit rate according to the indication).

Although various implementations disclosed herein are provided with respect to wearable devices, principles disclosed herein can be applied to any other type of devices such as handheld, mobile or small form factor devices (e.g., smart phones, tablet computers, laptops, etc.).

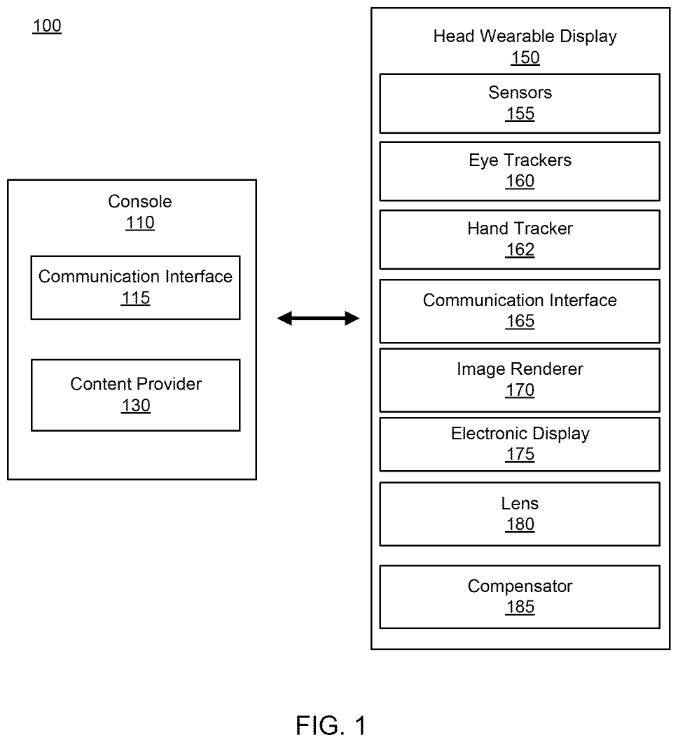

FIG. 1 is a block diagram of an example artificial reality system environment 100. In some implementations, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some implementations, the artificial reality system environment 100 includes more, fewer, or different components than shown in FIG. 1. In some implementations, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some implementations, the console 110 is integrated as part of the HWD 150.

In some implementations, the HWD 150 is an electronic component that can be worn by a user and can present or provide an artificial reality experience to the user. The HWD 150 may render one or more images, video, audio, or some combination thereof to provide the artificial reality experience to the user. In some implementations, audio is presented via an external device (e.g., speakers and/or headphones) that receives audio information from the HWD 150, the console 110, or both, and presents audio based on the audio information. In some implementations, the HWD 150 includes sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other implementations, the HWD 150 includes more, fewer, or different components than shown in FIG. 1.

In some implementations, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some implementations, the eye trackers 160 include electronic components or a combination of electronic components and software components that determine a gaze direction of the user of the HWD 150. In some implementations, the HWD 150, the console 110 or a combination of them may incorporate the gaze direction of the user of the HWD 150 to generate image data for artificial reality. In some implementations, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some implementations, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some implementations, a user of the HWD 150 can configure the HWD 150 (e.g., via user settings) to enable or disable the eye trackers 160. In some implementations, a user of the HWD 150 is prompted to enable or disable the eye trackers 160.

In some implementations, the hand tracker 162 includes an electronic component or a combination of an electronic component and a software component that tracks a hand of the user. In some implementations, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some implementations, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some implementations, the image renderer 170 includes an electronic component or a combination of an electronic component and a software component that generates one or more images for display, for example, according to a change in view of the space of the artificial reality. In some implementations, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some implementations, the image data from the console 110 may be encoded, and the image renderer 170 may decode the image data to render the image. In some implementations, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some implementations, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some implementations, the electronic display 175 is an electronic component that displays an image. The electronic display 175 may, for example, be a liquid crystal display or an organic light emitting diode display. The electronic display 175 may be a transparent display that allows the user to see through. In some implementations, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some implementations, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some implementations, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some implementations, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other implementations, the console 110 includes more, fewer, or different components than shown in FIG. 1. In some implementations, the console 110 is integrated as part of the HWD 150.

In some implementations, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

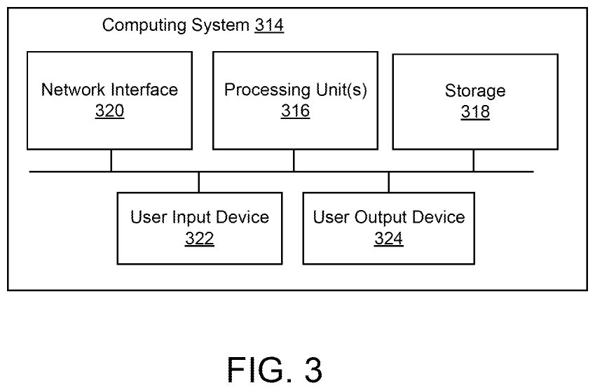

The content provider 130 can include or correspond to a component that generates content to be rendered according to the location and/or orientation of the HWD 150. In some implementations, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some implementations, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some implementations, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

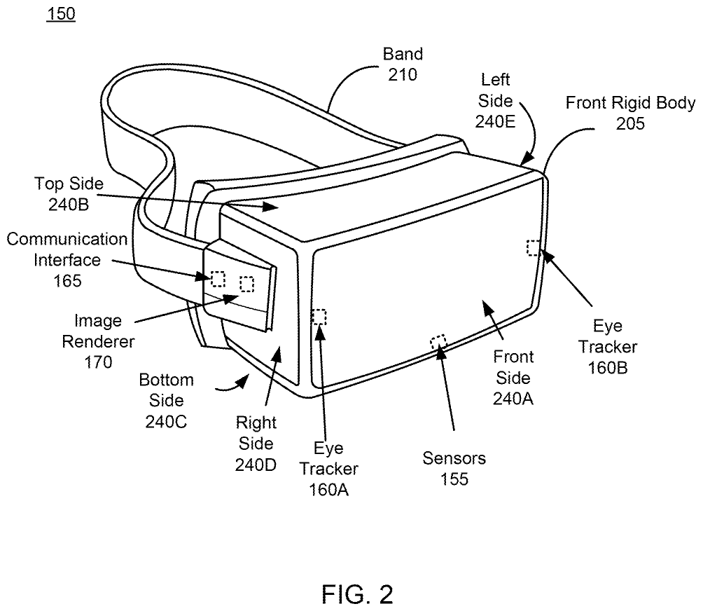

FIG. 2 is a diagram of a HWD 150, in accordance with an example implementation. In some implementations, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the implementation shown by FIG. 2, the communication interface 165, the image renderer 170, and the sensors 155 are located within the front rigid body 205, and may not visible to the user. In other implementations, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of a representative computing system 314 usable to implement the present disclosure. In some implementations, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some implementations, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

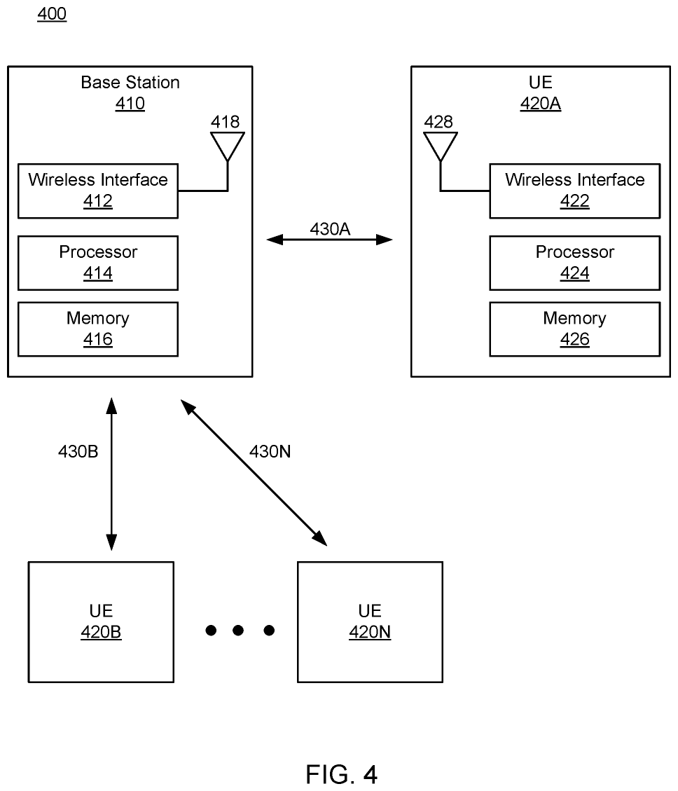

FIG. 4 illustrates an example wireless communication system 400. The wireless communication system 400 may include a base station 410 (also referred to as “a wireless communication node 410” or “a station 410”) and one or more user equipment (UEs) 420 (also referred to as “wireless communication devices 420” or “terminal devices 420”). The UEs 420 may be or include any device or component described above with reference to FIG. 1-FIG. 3, such as the console 110, head wearable display 150, or the like. The base station 410 and UEs 420 may include components, elements, and/or hardware similar to those described above with reference to FIG. 1-FIG. 3. The base station 410 and the UEs 420 may communicate through wireless commination links 430A, 430B, 430C. The wireless communication link 430 may be a cellular communication link conforming to 3G, 4G, 5G or other cellular communication protocols or a Wi-Fi communication protocol. In one example, the wireless communication link 430 supports, employs or is based on an orthogonal frequency division multiple access (OFDMA). In one aspect, the UEs 420 are located within a geographical boundary with respect to the base station 410, and may communicate with or through the base station 410. In some implementations, the wireless communication system 400 includes more, fewer, or different components than shown in FIG. 4. For example, the wireless communication system 400 may include one or more additional base stations 410 than shown in FIG. 4.

In some implementations, the UE 420 may be a user device such as a mobile phone, a smart phone, a personal digital assistant (PDA), tablet, laptop computer, wearable computing device, etc. Each UE 420 may communicate with the base station 410 through a corresponding communication link 430. For example, the UE 420 may transmit data to a base station 410 through a wireless communication link 430, and receive data from the base station 410 through the wireless communication link 430. Example data may include audio data, image data, text, etc. Communication or transmission of data by the UE 420 to the base station 410 may be referred to as an uplink communication. Communication or reception of data by the UE 420 from the base station 410 may be referred to as a downlink communication. In some implementations, the UE 420A includes a wireless interface 422, a processor 424, a memory device 426, and one or more antennas 428. These components may be embodied as hardware, software, firmware, or a combination thereof. In some implementations, the UE 420A includes more, fewer, or different components than shown in FIG. 4. For example, the UE 420 may include an electronic display and/or an input device. For example, the UE 420 may include additional antennas 428 and wireless interfaces 422 than shown in FIG. 4.

The antenna 428 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 428 may be a dipole antenna, a patch antenna, a ring antenna, or any suitable antenna for wireless communication. In one aspect, a single antenna 428 is utilized for both transmitting the RF signal and receiving the RF signal. In one aspect, different antennas 428 are utilized for transmitting the RF signal and receiving the RF signal. In one aspect, multiple antennas 428 are utilized to support multiple-in, multiple-out (MIMO) communication.

The wireless interface 422 includes or is embodied as a transceiver for transmitting and receiving RF signals through a wireless medium. The wireless interface 422 may communicate with a wireless interface 412 of the base station 410 through a wireless communication link 430A. In one configuration, the wireless interface 422 is coupled to one or more antennas 428. In one aspect, the wireless interface 422 may receive the RF signal at the RF frequency received through antenna 428, and downconvert the RF signal to a baseband frequency (e.g., 0˜1 GHz). The wireless interface 422 may provide the downconverted signal to the processor 424. In one aspect, the wireless interface 422 may receive a baseband signal for transmission at a baseband frequency from the processor 424, and upconvert the baseband signal to generate a RF signal. The wireless interface 422 may transmit the RF signal through the antenna 428.

The processor 424 is a component that processes data. The processor 424 may be embodied as field programmable gate array (FPGA), application specific integrated circuit (ASIC), a logic circuit, etc. The processor 424 may obtain instructions from the memory device 426, and executes the instructions. In one aspect, the processor 424 may receive downconverted data at the baseband frequency from the wireless interface 422, and decode or process the downconverted data. For example, the processor 424 may generate audio data or image data according to the downconverted data, and present an audio indicated by the audio data and/or an image indicated by the image data to a user of the UE 420A. In one aspect, the processor 424 may generate or obtain data for transmission at the baseband frequency, and encode or process the data. For example, the processor 424 may encode or process image data or audio data at the baseband frequency, and provide the encoded or processed data to the wireless interface 422 for transmission.

The memory device 426 is a component that stores data. The memory device 426 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 426 may be embodied as a non-transitory computer readable medium storing instructions executable by the processor 424 to perform various functions of the UE 420A disclosed herein. In some implementations, the memory device 426 and the processor 424 are integrated as a single component.

In some implementations, each of the UEs 420B . . . 420N includes similar components of the UE 420A to communicate with the base station 410. Thus, detailed description of duplicated portion thereof is omitted herein for the sake of brevity.

In some implementations, the base station 410 may be an evolved node B (eNB), a serving eNB, a target eNB, a next generation node B (gNb), a femto station, or a pico station. The base station 410 may be communicatively coupled to another base station 410 or other communication devices through a wireless communication link and/or a wired communication link. The base station 410 may receive data (or a RF signal) in an uplink communication from a UE 420. Additionally or alternatively, the base station 410 may provide data to another UE 420, another base station, or another communication device. Hence, the base station 410 allows communication among UEs 420 associated with the base station 410, or other UEs associated with different base stations. In some implementations, the base station 410 includes a wireless interface 412, a processor 414, a memory device 416, and one or more antennas 418. These components may be embodied as hardware, software, firmware, or a combination thereof. In some implementations, the base station 410 includes more, fewer, or different components than shown in FIG. 4. For example, the base station 410 may include an electronic display and/or an input device. For example, the base station 410 may include additional antennas 418 and wireless interfaces 412 than shown in FIG. 4.

The antenna 418 may be a component that receives a radio frequency (RF) signal and/or transmit a RF signal through a wireless medium. The antenna 418 may be a dipole antenna, a patch antenna, a ring antenna, or any suitable antenna for wireless communication. In one aspect, a single antenna 418 is utilized for both transmitting the RF signal and receiving the RF signal. In one aspect, different antennas 418 are utilized for transmitting the RF signal and receiving the RF signal. In one aspect, multiple antennas 418 are utilized to support multiple-in, multiple-out (MIMO) communication.

The wireless interface 412 includes or is embodied as a transceiver for transmitting and receiving RF signals through a wireless medium. The wireless interface 412 may communicate with a wireless interface 422 of the UE 420 through a wireless communication link 430. In one configuration, the wireless interface 412 is coupled to one or more antennas 418. In one aspect, the wireless interface 412 may receive the RF signal at the RF frequency received through antenna 418, and downconvert the RF signal to a baseband frequency (e.g., 0˜1 GHz). The wireless interface 412 may provide the downconverted signal to the processor 424. In one aspect, the wireless interface 422 may receive a baseband signal for transmission at a baseband frequency from the processor 414, and upconvert the baseband signal to generate a RF signal. The wireless interface 412 may transmit the RF signal through the antenna 418.

The processor 414 is a component that processes data. The processor 414 may be embodied as FPGA, ASIC, a logic circuit, etc. The processor 414 may obtain instructions from the memory device 416, and executes the instructions. In one aspect, the processor 414 may receive downconverted data at the baseband frequency from the wireless interface 412, and decode or process the downconverted data. For example, the processor 414 may generate audio data or image data according to the downconverted data. In one aspect, the processor 414 may generate or obtain data for transmission at the baseband frequency, and encode or process the data. For example, the processor 414 may encode or process image data or audio data at the baseband frequency, and provide the encoded or processed data to the wireless interface 412 for transmission. In one aspect, the processor 414 may set, assign, schedule, or allocate communication resources for different UEs 420. For example, the processor 414 may set different modulation schemes, time slots, channels, frequency bands, etc. for UEs 420 to avoid interference. The processor 414 may generate data (or UL CGs) indicating configuration of communication resources, and provide the data (or UL CGs) to the wireless interface 412 for transmission to the UEs 420.

The memory device 416 is a component that stores data. The memory device 416 may be embodied as RAM, flash memory, ROM, EPROM, EEPROM, registers, a hard disk, a removable disk, a CD-ROM, or any device capable for storing data. The memory device 416 may be embodied as a non-transitory computer readable medium storing instructions executable by the processor 414 to perform various functions of the base station 410 disclosed herein. In some implementations, the memory device 416 and the processor 414 are integrated as a single component.

In some implementations, communication between the base station 410 and the UE 420 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

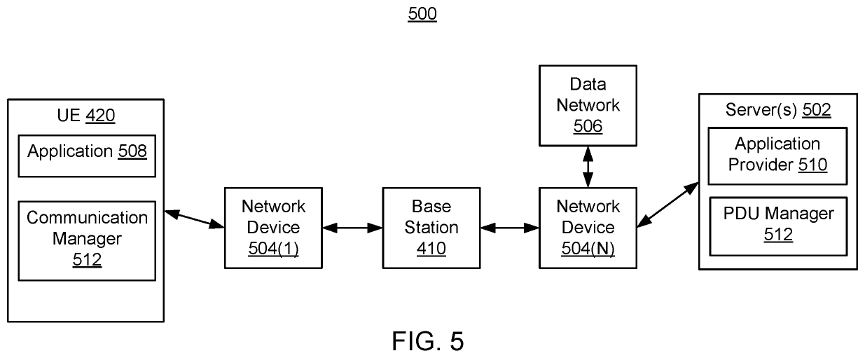

Referring now to FIG. 5, depicted is a block diagram of a system 500 that can implement operations including facilitating delay-aware network traffic provisioning, such as for XR traffic that can have bursty characteristics, according to an example implementation of the present disclosure. The system 500 may include user equipment (UE) 420 communicably coupled to one or more server(s) 502. The UE 420 may be the same as or similar to the UE 420 described above with reference to FIG. 4. The UE 420 may be communicably coupled to the server(s) 502 via various network devices 504 and base station 410. The base station 410 may be the same as or similar to the base station 410 described above with reference to FIG. 4. The network devices 504 may be or include any networking device, component, or node along the network path between the UE 420 and server(s) 502. For example, the network devices 504 may include routers, switches, or any other network nodes. In various implementations, the server(s) 502 may be configured to communicate with a data network 506 (e.g., a trusted data network 506) via a network exposure function and/or policy control function). The server(s) 502 may be configured to communicate data via a user plane function (UPF) to the base station 410 (e.g., a radio access network [RAN]), and the base station 410 may route the data from the server(s) 502 via various network devices 504 to the UE 420.

The UE 420 may be configured to execute an application 508 hosted by an application provider 510 on the server(s) 502. In various implementations, the application 508 may be an extended reality (XR) application (e.g., an augmented reality (AR), virtual reality (VR), mixed reality (MR), or other XR application). The application 508 executing on the UE 420 may generate data for transmission to the server 502 (and vice versa). The UE 420 (or server 502) may be configured to transmit the data along the network path shown in FIG. 5 and described above to the endpoint or destination (e.g., to the server 502 or UE 420).

The application 508 can generate one or more data packets to represent information to be transmitted to the base station 410, such as for transmission to servers 502 (e.g., for processing by the application provider 510). The data packets can have bursty characteristics; for example, an amount of data to be communicated using the data packets during one or more first periods of time can be greater than an amount of data to be communicated using the data packets during one or more second periods of time; the periods of time can correspond to a frame rate of data presentation and/or aperiodic data communication. The amount of data of the one or more first periods of time can be greater than of the one or more second periods of time by being, for example, at least twice as much data. In some implementations, the data packets have a bursty characteristic corresponding to an amount by which the data to be communicated varies relative to a target rate or expected rate.

The data packets can represent XR data. For example, the data packets can represent frames (e.g., video frames) of XR data that include image and/or audio data. The data packets can represent periodic data, such as where the XR data corresponds to periodic information. For example, periodic data can be data having a target rate for at least one communication or presentation, such as a target frame rate (e.g., frames per second).

The data packets can represent a least one of aperiodic or receiver-triggered data. For example, some information to be represented by the data packets can be transmitted responsive to a trigger condition or event, as compared with being transmitted in accordance with a periodic feature, such as a frame rate or display rate. Receiver-triggered information to be represented by the data packets can be transmitted responsive to a request from a receiving device, such as the server(s) 502.

The application 508 can apply encoding and/or compression to the frames in order to generate the one or more data packets to represent the frames as compressed frames. In some instances, the application 508 applies inter-frame compression to one or more frames. For example, the application 508 can encode a first frame in a manner that references data from a second frame, such as to generate P-frame and I-frame representations of the XR data. In some instances, the application 508 applies intra-frame compression to one or more frames. For example, the application 508 can encode a first frame independently of a second frame (e.g., a frame immediately before or immediately after the first frame).

The intra-frame compression can result in a relatively greater amount of data for representing the frames than inter-frame compression. As such, allocation of uplink grants for transmission by the UE 420 of the data packets may not be accurate if the allocation is determined, for example, based on an average of data flow rates for inter-frame or intra-frame compression. This can result in unused bandwidth, or communication delays and/or data discard (e.g., if timing criteria are not satisfied).

In various such implementations, the data packets generated by the application 508 can have a timing characteristic. The timing characteristic can correspond to a characteristic representative of bursty data flow rates of the data packets, such as based on an amount of the data of the data packets varying from an expected or periodic data rate, such as for semi-static communications. The timing characteristic can correspond to the data packets representing periodic or aperiodic and/or receiver-triggered information; the type of the timing characteristic can thus be used to facilitate more accurate uplink grant allocation by the base station 410.

The UE 420 can include at least one communication manager 512. The communication manager 512 can generate, based on the data packets and/or information received from the application 508 regarding the data packets, an indication of the timing characteristic of the data packets. For example, the communication manager 512 can assign a flag or bit to a control signal indicative of the timing characteristic. The communication manager 512 can generate the indication of the timing characteristic prior to transmission of the data packets (and/or a data burst that includes the data packets) for which the indication is determined, and can transmit the indication to the base station 410 prior to transmission of the data packets. In some implementations, the communication manager 512 generates the indication of the timing characteristic prior to completion of generation of each data packet (or other sub-element) of the plurality of data packets; for example, the communication manager 512 can receive information from the application 508 indicative of the timing characteristic regarding the data packets, such as an identifier of the application 508 and/or the data packets that indicates that the data packets represent periodic data, or an identifier of a compression scheme or technique used by the application 508.

The communication manager 512 can provide the timing characteristic to the base station 410, which can enable the base station 410 to more effectively allocate communication grants (e.g., data rates) to the UE 420 for the UE 420 to transmit the data packets to the base station 410. By providing the indication for receipt by the base station 410, the communication manager 512 can enable the base station 410 to perform the allocation of communication grants with a relatively lightweight signal (e.g., using UAI or other signals described herein) while mitigating or avoiding the need for the base station 410 to process the data packets in order to detect the timing characteristic (which may not be feasible for latency-dependent communications). For example, based on the information indicated by the indication of the timing characteristic (e.g., whether the data packets have intra-frame compression or inter-frame compression; whether the data packets represent periodic or aperiodic communications), the base station 410 can more accurately allocate communication grants, such as bandwidth, data flow rate, and/or bit rate for communication by the UE 420. For example, the base station 410 can be enabled to avoid over-allocating grants to the UE 420 (e.g., where the data packets represent inter-frame compressed XR data) or under-allocating grants to the UE 420 (e.g., where the data packets represent inter-frame compressed XR data). In some implementations, communicating the timing characteristic to indicate that the data packets represent aperiodic and/or receiver-triggered information can allow the UE 420 to indicate to the base station 410 how to more dynamically adjust the uplink grants to real-time communication demands.

In some implementations, the communication manager 512 can receive, from the base station 410, the communication rate in accordance with a logical channel prioritization, such as to receive the communication rate as at least one of a prioritized bit rate (PBR) or a guaranteed bit rate (GBR). For example, the PBR can represent a bit rate for a given channel by which the UE 4210 is to communicate the plurality of data packets to the base station 410 (e.g., before providing further bit rates to lower priority communications). The base station 410 can select, for example, at least one of the PBR or a priority for the data packets according to the timing characteristic. The GBR can represent the ability of the UE 420 to communicate the data packets with at least a bit rate amount represented by the GBR, such as where the data packets are for high priority communication to be guaranteed (e.g., compared with radio data bearers that do not have guaranteed bit rates).

Referring further to FIG. 5, in some implementations, the communication manager 512 communicates the timing characteristic to the base station 410 using a user assistance information (UAI) signal. The UAI signal can be a message transmitted using radio resource control (RRC) signaling. By using RRC, the communication manager 512 can provide the timing characteristic to the base station 410 using a predetermined communication mechanism to efficiently inform the base station 410 of the timing characteristic.

In some implementations, the communication manager 512 communicates the timing characteristic to the base station 410 using at least one of an uplink control information (UCI) signal or a media access control (MAC) control element (CE) signal. The UCI signal can be communicated using at least one of a Physical Uplink Control Channel (PUCCH) or a Physical Uplink Channel (PUSCH). The MAC CE signal can be a portion of a MAC header signal and/or payload (e.g., in a MAC PDU), and the communication manager 512 can include the timing information in the MAC header signal, for example.

The communication manager 512 can select one or more communication techniques (e.g., UAI, RRC, UCI, and/or MAC CE, among others) according to the timing characteristic. This can include, for example, selecting a first communication technique (e.g., channel, scheme, communication layer) responsive to the timing characteristic being indicative of periodic data, and selecting a second communication technique different from the first communication technique responsive to the timing characteristic being indicative of aperiodic and/or receiver-triggered data. For example, the communication manager 512 can select the UAI signal to communicate the indication of the timing characteristic responsive to the data packets being at least one of periodic or having intra-frame compression. The communication manager 512 can select the at least one of the UCI signal or the MAC CE signal responsive to the data packets being aperiodic and/or receiver-triggered. By selecting the communication technique according to the timing characteristic, the communication manager 512 can enable to base station 410 to selectively and/or more efficiently perform allocation of communication grants.

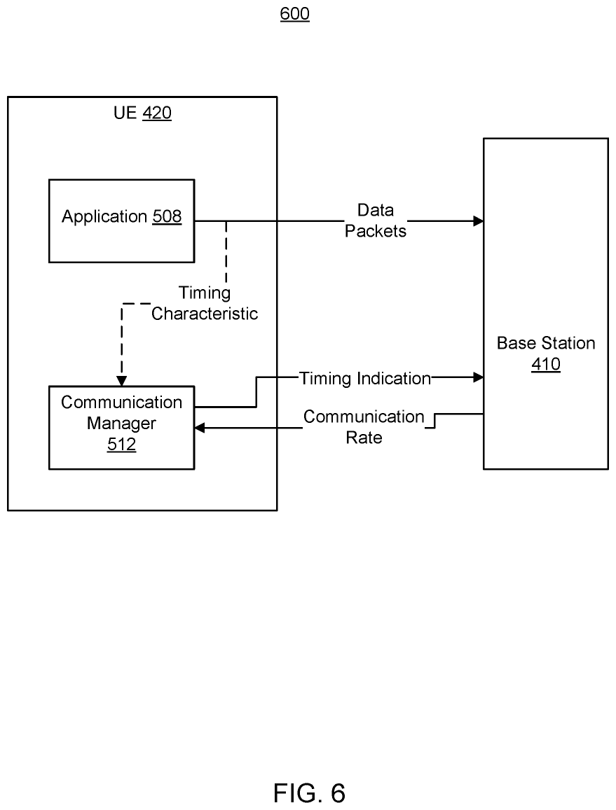

FIG. 6 depicts an example of a process 600 implemented by the UE 420 and/or base station 410 to facilitate delay-aware traffic provisioning, such as for bursty network communication traffic. The process 600 can be implemented using any of various systems and devices described herein.

As shown in FIG. 6, the application 508 can generate one or more data packets for communication (e.g., uplink from the UE 420) to the base station 410, such as for the base station 410 to provide to the server(s) 502 for processing by the server(s) 502. The communication manager 512 can determine a timing characteristic of the data packets. In some implementations, the communication manager 512 determines the timing characteristic based on evaluation of the data packets. For example, the communication manager 512 can parse the data packets to identify a type of information (e.g., video data, audio data, XR data) represented by the data packets, and determine the timing characteristic based on the type of information. In some implementations, the communication manager 512 receives the indication from the application 508. In some implementations, the communication manager 512 determines the timing characteristic based on at least one of a type of the application 508 or a destination for the data packets indicated by the data packets.

The communication manager 512 can provide an indication of the timing characteristic to the base station 410. For example, the communication manager 512 can include the indication in any one or more of various messages and/or communication channels between the UE 420 and base station 410, such as one or more layers of Open Systems Interconnection (OSI) model. By providing the indication of the timing characteristic, such as to indicate whether the timing characteristic corresponds to periodic or aperiodic data (or to a type of compression of the data packets, which can indicate bandwidth demands for transmitting the data packets), the communication manager 512 can facilitate allocation of communication grants by the base station 410.

For example, the communication manager 512 can receive a communication rate (e.g., indication of a communication rate), from the base station 410, for the communication of the data packets to the base station 410. In some implementations, responsive to the timing characteristic indicating that the data packets have intra-frame compression, the communication manager 512 can receive a relatively high communication rate from the base station 410, such as a communication rate greater than an average rate of intra-frame and inter-frame compression data rates. In some implementations, responsive to the timing characteristic indicating that the data packets have inter-frame compression, the communication manager 512 can receive a relatively low communication rate from the base station 410, such as a communication rate less than an average rate of intra-frame and inter-frame compression data rates. The UE 420 (e.g., using wireless interface 412) can transmit the data packets to the base station 410 according to the communication rate received from the base station 410.

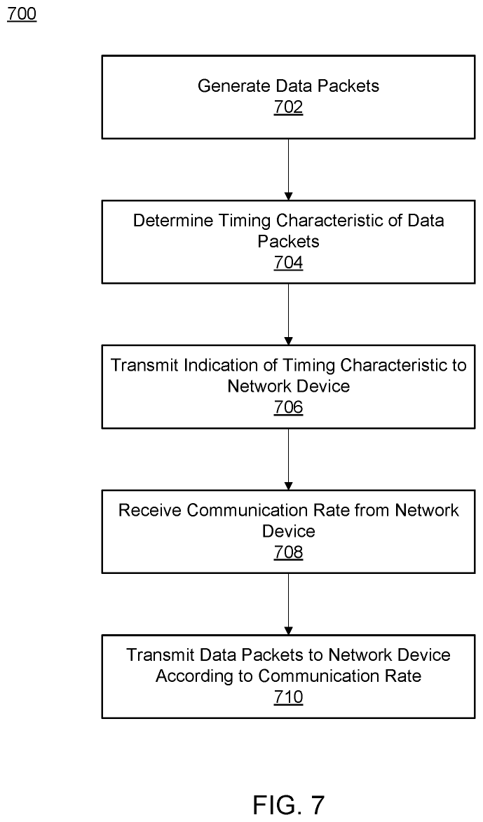

FIG. 7 shows a block diagram of a representative method 700 for network traffic provisioning according to data burst timing characteristics. In some implementations, the method 700 can be implemented by a device, such as a UE, configured to communicate with a second device, such as a base station, using a wireless connection. In brief overview, the method can include generating 702 a plurality of data packets. The method can include determining 704 a timing characteristic of the plurality of data packets. The method can include transmitting 706, using a wireless communication interface of the device, the indication of the timing characteristic to a network device. The method can include receiving 708, from the network device, a communication rate for transmission of the plurality of data packets. The method can include transmitting 710 the data packets to the network device according to the received communication rate. In some implementations, the method 700 can be performed by the wearable device 110 or the wearable device 150. In some implementations, the method 700 can be performed by other entities. In some implementations, the method 700 includes more, fewer, or different steps than shown in FIG. 7, or in different orders than shown in FIG. 7 (e.g., the determination of the timing characteristic can be performed prior to at least some of the generation of the data packets).

Referring to FIG. 7 in further detail, one or more processors of the device can generate 702 a plurality of data packets. The data packets can be generated by an application, such as an XR application, of the device. The data packets can be formatted as one or more PDUs, such as to be arranged as PDU sets for communication as/in one or more data bursts. For example, the one or more processors can generate the data packets to include multiple data packets representing video frame of XR data to be communicated in one or more data bursts (e.g., at a periodicity, such as a periodicity). In some implementations, at least a subset of the data packets have a periodicity. For example, the data packets can have a fixed periodicity, such as by being generated and/or scheduled for communication at periodic times, e.g., in accordance with a frame rate associated with XR content represented by the data packets. The data packets can be arranged in data bursts, such as to have a plurality of first data packets forming a first data burst and a plurality of second data packets forming a second data burst, the first data burst having a first period between consecutive packets of the plurality of first data packets, the second data burst having a second period between consecutive packets of the plurality of second data packets, the first period and the second period each less than a third period between the first data burst and the second data burst. The data packets can be compressed and/or encoded using various compression techniques, such as intra-frame compression or inter-frame compression. The data packets can be aperiodic and/or receiver-triggered (e.g., generated responsive to a request from a receiver device, such as a server hosting an application for processing of the data packets to serve content to the application of the UE 420).

The one or more processors can determine 704 a timing characteristic of the data packets. The timing characteristic can represent a characteristic representative of bursty data flow rates of the data packets, such as based on an amount of the data of the data packets varying from an expected or periodic data rate, such as for semi-static communications. The timing characteristic can correspond to the data packets representing periodic or aperiodic and/or receiver-triggered information. The timing characteristic can represent a type of the data of the data packets (e.g., that the data packets are XR data), which can correspond to the data being periodic.

The one or more processors can transmit 706, using a wireless communications interface, an indication of the timing characteristic to the network device. For example, the one or more processors can use one or more control signals or other targeted signals to communicate the indication, such as to assign the indication as a bit, flag, or message to a predetermined field of the control signal to communicate the indication to the network device. This can include, for example, including the indication in a UAI signal, a UCI signal, or a MAC CE signal. In some implementations, the one or more processors select the signal to use for communication of the indication according to the indication (e.g., according to the timing characteristic and/or a type of the timing characteristic). For example, the one or more processors can select the UAI signal to communicate the indication responsive to the timing characteristic indicating that the data packets represent periodic data. The one or more processors can select at least one of the UCI signal or the MAC CE signal responsive to the timing characteristic indicating that the data packets represent at least one of aperiodic or receiver-triggered data.

The one or more processors can receive 708, from the network device, a communication rate. The communication rate can be determined by the network device according to the timing characteristic. The communication rate can be for the one or more processors to transmit the generated data packets to the network device. In some implementations, the communication rate indicates a bit rate for communication of the generated data packets, such as for communication of a given data burst for which the timing characteristic is determined. In some implementations, the communication rate corresponds to at least one of a PBR or a GBR.

The one or more processors can transmit 710 the plurality of data packets to the network device according to the communication rate received from the network device. For example, the one or more processors 710 can allocate the data packets to one or more logical and/or physical channels according to the communication rate, and cause the wireless communications interface to transmit the data packets according to the communication rate from the one or more logical and/or physical channels.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 316 can provide various functionality for the computing system 314, including any of the functionality described herein as being performed by a server or client, or other functionality associated with message management services.

It will be appreciated that the computing system 314 is illustrative and that variations and modifications are possible. Computer systems used in connection with the present disclosure can have other capabilities not specifically described here. Further, while the computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
a wireless communications interface to communicate a plurality of data packets to a network device; and
one or more processors to:
generate the plurality of data packets according to a timing characteristic of the plurality of data packets;
provide an indication of the timing characteristic to the network device;
receive a communication rate from the network device; and
cause the wireless communications interface to communicate the plurality of data packets to the network device according to the communication rate.

2. The device of claim 1, wherein the plurality of data packets are representative of video frames, and the timing characteristic corresponds to a compression of the video frames being intra-frame compression or inter-frame compression.

3. The device of claim 2, wherein the one or more processors are to generate the indication based at least on the inter-frame compression having a greater data usage than the inter-frame compression.

4. The device of claim 1, wherein the timing characteristic corresponds to the plurality of data packets being representative of periodic data.

5. The device of claim 4, wherein the one or more processors are to generate a user assistance information (UAI) signal comprising the indication of the timing characteristic and transmit the UAI signal to the network device to provide the indication of the timing characteristic to the network device.

6. The device of claim 5, wherein the one or more processors are to communicate the indication to the network device using radio resource control (RRC) signaling.

7. The device of claim 1, wherein the one or more processors are to:
communicate the indication of the timing characteristic to the network device, using at least one of an uplink control information (UCI) signal or a media access control (MAC) control element (CE) signal, responsive to a determination that the timing characteristic corresponds to at least one of the plurality of data packets being aperiodic or being receiver-triggered.

8. The device of claim 1, wherein the plurality of data packets form a data burst.

9. A system, comprising:
a first device, comprising:
one or more first processors to generate a plurality of data packets according to a timing characteristic of the plurality of data packets; and
a second device, comprising:
one or more second processors to:
receive an indication of the timing characteristic from the first device; and
transmit, to the first device, according to the indication of the timing characteristic, a communication rate for communication of the plurality of data packets from the first device to the second device.

10. The system of claim 9, wherein the plurality of data packets are representative of video frames, and the timing characteristic corresponds to a compression of the video frames being intra-frame compression or inter-frame compression.

11. The system of claim 10, wherein the one or more first processors are to generate the indication based at least on the inter-frame compression having a greater data usage than the inter-frame compression.

12. The system of claim 10, wherein the timing characteristic corresponds to the plurality of data packets being representative of periodic data.

13. The system of claim 12, wherein the one or more first processors are to generate a user assistance information (UAI) signal comprising the indication of the timing characteristic and transmit the UAI signal to the second device using radio resource control (RRC) signaling to provide the indication of the timing characteristic to the second device.

14. The system of claim 9, wherein the one or more first processors are to:
communicate the indication of the timing characteristic to the second device, using at least one of an uplink control information (UCI) signal or a media access control (MAC) control element (CE) signal, responsive to a determination that the timing characteristic corresponds to at least one of the plurality of data packets being aperiodic or being receiver-triggered.

15. A method, comprising:
generating, by one or more processors, a plurality of data packets;
determining, by the one or more processors, a timing characteristic of the plurality of data packets;
transmitting, by the one or more processors, using a wireless communications interface, an indication of the timing characteristic to a network device;
receiving, by the one or more processors, using the wireless communications interface, from the network device, a communication rate for the plurality of data packets; and
transmitting, by the one or more processors, using the wireless communications interface, the plurality of data packets to the network device.

16. The method of claim 15, wherein:
the plurality of data packets are representative of video frames;
the timing characteristic corresponds to a compression of the video frames being intra-frame compression or inter-frame compression; and
the method further comprises determining, by the one or more processors, the timing characteristic based on the inter-frame compression having a greater data usage than the inter-frame compression.

17. The method of claim 15, wherein the timing characteristic corresponds to the plurality of data packets being representative of periodic data.

18. The method of claim 16, further comprising:
generating, by the one or more processors, a user assistance information (UAI) signal comprising the indication of the timing characteristic; and
transmitting, by the one or more processors using the wireless communications interface, the UAI signal to the network device to provide the indication of the timing characteristic to the network device.

19. The method of claim 16, further comprising communicating, by the one or more processors using the wireless communications interface, the indication of the timing characteristic to the network device, using at least one of an uplink control information (UCI) signal or a media access control (MAC) control element (CE) signal, responsive to a determination that the timing characteristic corresponds to at least one of the plurality of data packets being aperiodic or being receiver-triggered.

20. The method of claim 15, wherein the plurality of data packets form a data burst.
